(19) United States
(12) Patent Application Publication
(10) Pub. No.: US 2006/0136104 A1
(43) Pub. Date: Jun. 22, 2006

(54) Distributed diagnostic system

(75) Inventors: Steve Brozovich, Santa Clara, CA (US); Dale Trsar, Mount Prospect, IL (US); Jeff Grier, Royal Oak, MI (US); Jim Cancilla, San Jose, CA (US); Sunil Reddy, Corpus Christi, TX (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Snap-on Incorporated, Kenosha, WI (US)

(21) Appl. No.: 11/021,097

(22) Filed: Dec. 22, 2004

(51) Int. Cl. G01M 17/00

(52) U.S. Cl. 701/29

(57) ABSTRACT

A method and system diagnosing vehicle faults using a diagnostic tool capable of communicating with a remote host. Diagnostic data, vehicle data, and a diagnostic routine are stored in data storage of a diagnostic tool. The diagnostic data defines vehicle fault descriptions, corresponding vehicle fault symptoms, and corresponding repair instructions, and the vehicle data defines vehicle operation information. The diagnostic tool is capable of communicating with a remote host that can diagnose vehicle faults using the vehicle data, and send diagnosis information, including a diagnosis and repair instructions to the diagnostic tool. In response to receiving diagnosis information from the remote host, the diagnostic tool displays the information to a user. Advantageously, the system and method can allow the diagnostic tool access to additional computing power and external databases for diagnosing vehicle faults.

### BACKGROUND

1. Field of the Application

This application relates generally to test and diagnosis systems for machines or other operating apparatus, and has particular application to automotive vehicles, particularly vehicles powered by an internal combustion engine. While the application is described in the context of a vehicle diagnostic system and method, the principles of the present application are equally applicable for air conditioning testing and servicing systems, wheel systems, as well as for various non-automotive apparatus.

2. Description of Related Art

A number of different types of diagnostic tools have been used to assist in diagnosis and repair of fault conditions in automotive vehicles. Such diagnostic tools can typically be connected to an on-board computer of a vehicle in order to download and analyze vehicle operational information from the on-board computer. Additionally, such diagnostic tools typically allow a user to enter information, including fault symptoms, into the diagnostic tool to be used instead of or in conjunction with the information downloaded from the vehicle's on-board computer to diagnose and assist in the repair of fault conditions in the vehicle.

Automotive vehicles are becoming highly computerized products. Consequently, automotive mechanics are increasingly relying upon computerized diagnosis of vehicle operational information that can be accessed via a vehicle on-board computer to diagnose and repair vehicle faults. Additionally, today's vehicles may have large amounts of operational information that can be accessed via the vehicle on-board computers. As the amount of information that is accessible via vehicle on-board computers increases, the memory and processing power of diagnostic tools required to process such information also increases. Further, due to the highly computerized nature of today's automotive vehicles, it may be advantageous to allow a diagnostic tool to search large data bases to aid in diagnosing vehicle fault conditions. Such databases are often far too large to be stored in the memory of typical diagnostic tools, which are often handheld devices.

Providing diagnostic tools with adequate processing power and memory to support large amounts of information processing and/or data storage would likely result in more expensive and more cumbersome diagnostic tools. Additionally, every time a database is updated, it would be necessary to update such database on every diagnostic tool. Updating every diagnostic tool when information is added to or changed in a diagnostic database would take large amounts of time and resources, and many diagnostic tools would likely not be updated immediately, resulting in less effective diagnosis of vehicle faults than is possible with an updated database.

Therefore, a diagnostic tool with the ability to communicate with a remote host, where the remote host may, among other things, assist the diagnostic tool in analyzing data and searching databases, would be desirable.

### SUMMARY

The present application provides an improved method and system for diagnosing vehicle faults. According to one embodiment of the application, a diagnostic tool is provided that has a processing unit, a vehicle communication interface, a network communication interface, an output device for communicating with a user, data storage, and a diagnostic routine executable by the processing unit to (i) download data from the on-board computer of a vehicle, (ii) communicate with a remote host, and (iii) provide diagnosis information to the user. The diagnostic tool receives data from the on-board computer of the vehicle via the vehicle communication interface, and the diagnostic tool communicates with the remote host via the network communication interface.

### BRIEF DESCRIPTION OF THE DRAWINGS

FIG. 1 is a block diagram illustrating a diagnostic tool in accordance with one embodiment of the present application;

FIG. 2 is a block diagram illustrating a remote host in accordance with one embodiment of the present application;

FIG. 3 is a block diagram illustrating a diagnostic system coupled to a vehicle in accordance with one embodiment of the present application;

FIG. 4 is a flowchart illustrating a functional process flow for the diagnostic tool of FIG. 1; and

FIG. 5 is a flowchart illustrating a functional process flow for the remote host of FIG. 2.

### DETAILED DESCRIPTION

The embodiments described herein may include or be utilized with any appropriate voltage or current source, such as a battery, an alternator, a fuel cell, and the like, providing any appropriate current and/or voltage, such as about 12 Volts, about 42 Volts and the like.

The embodiments described herein may be used with any desired system or engine. Those systems or engines may comprise items utilizing fossil fuels, such as gasoline, natural gas propane, and the like, electricity, such as that generated by battery, magneto, fuel cell, solar cell and the like, wind and hybrids or combinations thereof. Those systems or engines may be incorporated into other systems, such as an automobile, a truck, a boat or ship, a motorcycle, a generator, an airplane, and the like.

1. Architecture

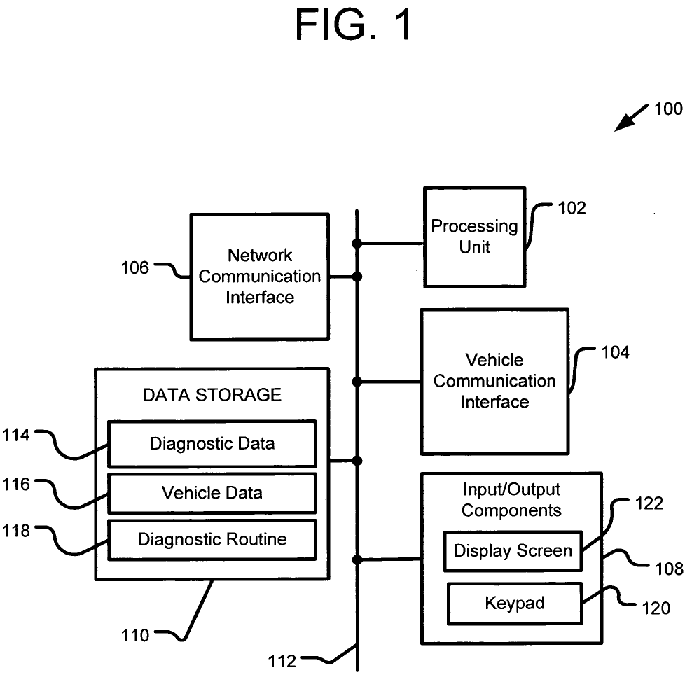

Referring to the drawings, FIG. 1 is a block diagram illustrating components of a diagnostic tool 100 in accordance with an embodiment of the present application. As illustrated, the diagnostic tool 100 may include a processing unit 102, a vehicle communication interface 104, a network communication interface 106, input/output components 108, and data storage 110—all coupled to a bus 112 or similar mechanism. In one embodiment, the data storage 110 may store data, including diagnostic data 114 and vehicle data 116, as well as computer instructions, including a diagnostic routine 118, executable by the processing unit 102. The diagnostic tool 100 could take on many forms, including, in one embodiment, a handheld device (e.g., a personal digital assistant (PDA), Palm OS device, Pocket PC, handheld computer, etc.). Alternatively, the diagnostic tool 100 may be a personal computer, such as a laptop or notebook computer.

The processing unit 102 could be one or more processors, such as a general-purpose processor and/or a digital signal processor. Other types of processors are also possible for use with the diagnostic tool 100.

The vehicle communication interface 104 of the diagnostic tool 100 can be used to communicatively couple the diagnostic tool 100 to an automotive vehicle on-board computer to facilitate communication between the diagnostic tool 100 and the on-board computer.

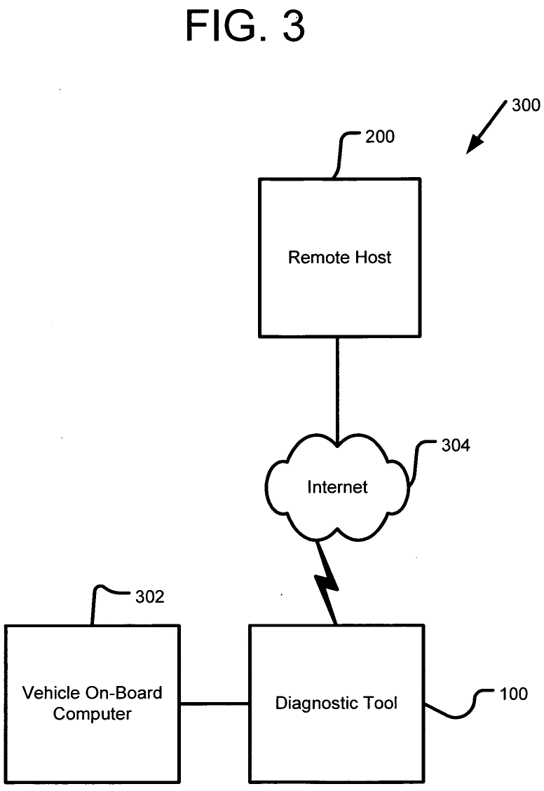

The network communication interface 106 of the diagnostic tool 100 can facilitate communication between a remote host (e.g., a server on a network, such as the Internet) and the diagnostic tool 100 via a direct link or a wired or wireless network, depending on the type of device (FIG. 3 illustrates a wireless configuration). A wireless network communication interface 106 would include a suitable antenna and transceiver circuitry (e.g., a Qualcomm™ MSM Series chipset) to facilitate communication over an air interface with a wireless network. Standard air interface protocols such as CDMA, GSM, TDMA, 802.11, or Bluetooth, as well as others, could be used. Other circuitry and/or air interface protocols are also possible for use with the diagnostic tool 100. A wired network interface 106 may include a standard local area network (LAN) network card, as is known in the art.

Input/output components 108 of the diagnostic tool 100 can facilitate interaction with a user of the diagnostic tool 100 and allow the user to input information into the diagnostic tool 100 regarding vehicle symptoms, and display information regarding a vehicle diagnosis, for instance. As such, the input/output components 108 might include a keypad 120 as an input component and a display screen 122 as an output component, for instance. The diagnostic tool 100 might also comprise other and/or additional or fewer input and output components than those shown in FIG. 1.

Data storage 110 may be any medium or media readable by the processing unit 102, such as magnetic discs, optical discs, and/or any other volatile or non-volatile mass storage system. The data storage 110 may store data, including diagnostic data 114 and vehicle data 116, and/or machine-readable instructions, including the diagnostic routine 118. The data storage 110 may store other and/or additional or fewer data and/or machine-readable instructions than those shown in FIG. 1. The data storage 110 may store other and/or additional or fewer data and/or machine-readable instructions than those shown in FIG. 1.

The diagnostic data 114 may define a plurality of vehicle fault conditions and, for each fault condition, a plurality of corresponding fault symptoms, a plurality of corresponding operational conditions, and corresponding repair instructions for repairing the fault condition. The diagnostic data 114 is preferably contained in a database or a table. Other and/or additional information could be contained in the diagnostic data 114 and its related database or table.

The vehicle data 116 may define information regarding the operation of a vehicle. The vehicle data 116 may be downloaded from a vehicle's on-board computer and/or entered by a user via an input device, such as the keypad 120. The vehicle data 116 is preferably contained in a text file or a table. Other and/or additional information could be contained in the vehicle data 116 and its related text file or table.

The diagnostic routine 118 may contain instructions for (i) receiving vehicle data 116 from a vehicle via the vehicle communication interface 104, (ii) processing the vehicle data 116 and/or comparing it to information contained in the diagnostic data 114, (iii) determining whether additional computing power and/or a large data base search is necessary, (iv) in response to the determination, sending the information stored in the vehicle data 116 to a remote host, (v) receiving a vehicle fault diagnosis and/or instructions for repairing the fault from the remote host, and (iv) in response to receiving this information, outputting the fault diagnosis and/or instructions to the user via an output component (e.g., the display screen 122). The diagnostic routine 118 may contain other and/or additional or fewer instructions than those mentioned herein. In an alternative embodiment, the diagnostic routine 118 may be implemented, at least in part, in hardware accessible to the processing unit 102.

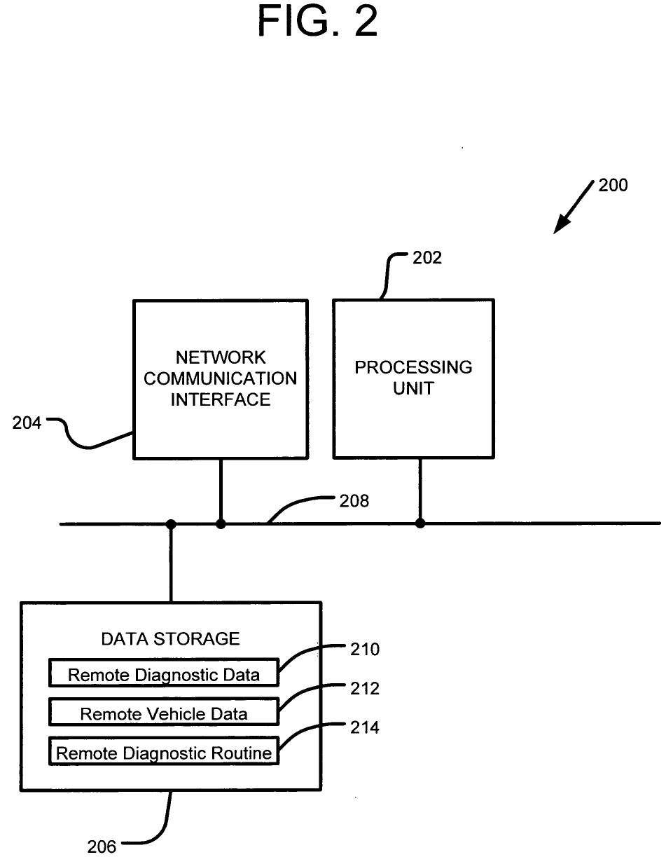

FIG. 2 is a block diagram illustrating components of a remote host 200 in accordance with an embodiment of the present application. As illustrated, the remote host 200 may include a processing unit 202, a network communication interface 204, and data storage 206—all coupled to a bus 208 or similar mechanism. In one embodiment, the data storage 206 may store data, including remote diagnostic data 210 and remote vehicle data 212, as well as computer instructions, including remote diagnostic routine 214, executable by the processing unit 202.

The processing unit 202 could be one or more processors, such as a general-purpose processor and/or a digital signal processor. Other types of processors are also possible for use with the remote host 200.

The network communication interface 204 of the remote host 200 can facilitate communication between the remote host 200 and the diagnostic tool 100 via a data network (e.g., the Internet).

Data storage 206 may be any medium or media readable by the processing unit 202, such as magnetic discs, optical discs, and/or any other volatile or non-volatile mass storage system. The data storage 206 may store data, including remote diagnostic data 210 and remote vehicle data 212, and/or machine-readable instructions, including the remote diagnostic routine 214.

Similar to the information stored in the diagnostic data 114 of the diagnostic tool 100, the remote diagnostic data 210 may define a plurality of vehicle faults and, for each fault, at least one corresponding symptom, and instructions to repair the fault. However, the information stored in the remote diagnostic data 210 may be far more detailed and complete than that stored in the diagnostic data 114 of the diagnostic tool 100. The remote diagnostic data 210 is preferably contained in a database or a table. Other and/or additional information could be contained in the diagnostic data and its related database or table.

The information stored in the remote vehicle data 212 may be identical to that stored in the vehicle data 116 of the diagnostic tool 100. The remote host 200 may store the information stored in the vehicle data 116 to the remote vehicle data 212 upon receipt of such information from the diagnostic tool 100, via the remote host's network communication interface 204. The remote vehicle data 212 may contain other and/or less or additional information than that stored in the vehicle data 116.

The remote diagnostic routine 214 may contain instructions for (i) receiving the information stored in the vehicle data 116 from the diagnostic tool 100, (ii) storing the received information in the remote vehicle data 212, (iii) comparing the remote vehicle data 212 to the remote diagnostic data 210, (iv) determining what vehicle fault condition exists, if any, for the vehicle in response to the comparison, and (v) sending a vehicle fault diagnosis and/or repair instructions, for instance, to the diagnostic tool 100 in response to the comparison. The remote diagnostic routine 214 may alternatively contain other and/or additional or fewer instructions than those mentioned herein. In an alternative embodiment, the remote diagnostic routine 214 may be at least partially implemented in hardware accessible to the processing unit 202. Additionally, the components of the remote host 200 illustrated in FIG. 2 could be distributed between various devices.

FIG. 3 is a block diagram illustrating components of a diagnostic system 300 communicatively coupled to a vehicle on-board computer 302, in accordance with one embodiment of the present application. As illustrated, the diagnostic tool 100 may be communicatively coupled to the vehicle on-board computer 302 via the diagnostic tool's vehicle communication interface 104 and to the remote host 200 via a network 304 (e.g., the Internet) using its network communication interface 106. The connection between the diagnostic tool 100 and the Internet 304 may be wired or wireless, as is illustrated in FIG. 3.

2. Operation

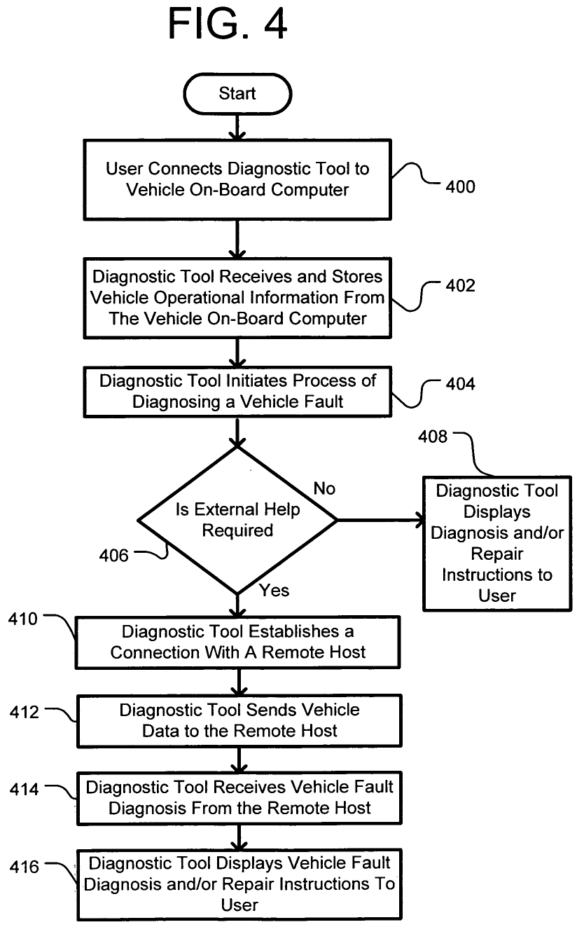

FIG. 4 is a flow chart that illustrates functions performed by the diagnostic tool 100 in accordance with one embodiment of the present application. At step 400, a user connects the diagnostic tool 100 to a vehicle on-board computer 302 via the diagnostic tool's vehicle communication interface 104. In response to being connected to the vehicle on-board computer 302, the diagnostic tool 100 receives, at step 402, vehicle operational information from the vehicle on-board computer 302, and stores the operational information in the vehicle data 116 in data storage 110. The remote diagnostic routine 214 may contain instructions to allow the diagnostic tool 100 to perform this step.

After the vehicle data 116 has been stored in the data storage 110, the diagnostic tool 100, at step 404, initiates a process of diagnosing a vehicle fault. The diagnostic routine 118 may contain instructions for the initiation, and the initiation may involve the diagnostic tool 100 analyzing the vehicle operational information stored in the vehicle data 116 and/or comparing such information to the information stored in the diagnostic data 114, for instance. Next, at step 406, the diagnostic tool 100 determines whether additional processing power or a larger data base search would be desirable to diagnose the vehicle fault. The diagnostic tool 100 can make this determination by attempting to diagnose the vehicle fault by comparing the vehicle data 116 to the diagnostic data 114, for instance. If the diagnostic tool 100 diagnoses the fault within a threshold period of time (e.g., 30 seconds), the diagnostic tool 100 may output a description of and/or instructions to repair the fault to the user at step 408. The diagnostic routine 118 may contain instructions for displaying this information to the user. These instructions may cause the processor 102 to access the vehicle fault and repair instructions stored in the diagnostic data 114 that correspond to the diagnosed fault. Upon accessing such information in the diagnostic data 114, the diagnostic tool 100 can output the description to a user via the display screen 122, for instance. Other output methods, such as playing an audio recording over a speaker, are possible.

If, at step 406, the diagnostic tool 100 determines that additional processing power or an external database search would be desirable (e.g., the threshold period of time expired before a fault could be diagnosed), the diagnostic tool 100, at step 410, establishes a connection with a remote host 200 over a network, such as the Internet 304. The diagnostic tool 100 can perform this step via the stored diagnostic routine 118 and the network communication interface 106. The connection between the network 304 and the diagnostic tool 100 may be a wireless or wired connection. Upon establishing a connection with the remote host 200 via the network 304, the diagnostic tool 100 sends the information stored in the vehicle data 116 to the remote host at step 412.

Next, at step 414, the diagnostic tool 100 receives an indication of the vehicle fault from the remote host 200 via the network 304. The diagnostic tool 100 may also receive additional diagnosis information, such as repair instructions, from the remote host 200 via the network 304. Upon receiving the indication, the diagnostic tool 100, at step 416, outputs the diagnosis and/or repair instructions to a user via the display screen 122, for instance, in a manner such as that described above. In an alternative embodiment, the diagnostic tool 100 may establish a connection with the remote host 200 immediately (i.e., before attempting to diagnose the vehicle fault independently).

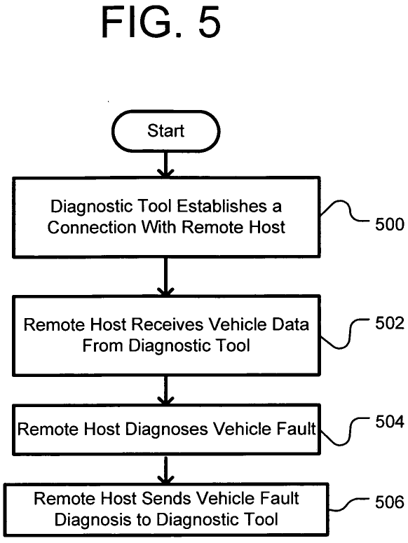

FIG. 5 is a flow chart that illustrates functions performed by the remote host 200 in accordance with one embodiment of the present application. At step 500, a connection is established between the diagnostic tool 100 via a network 304 (e.g., the Internet). Next, at step 502, the remote host receives vehicle operational information (i.e., the information stored in the vehicle data 116 in the diagnostic tool 100) from the diagnostic tool 100, and stores the information in the remote vehicle data 212 in data storage 206. After the received vehicle operational information has been stored in the remote vehicle data 212, the remote host 200 diagnoses the vehicle fault at step 504. The remote diagnostic routine 214 can contain instructions for doing this and can cause the remote host 200 to compare the remote vehicle data 212 to the remote diagnostic data 210 to diagnose the vehicle fault. Finally, at step 506, the remote host 200 sends an indication of the diagnosed vehicle fault and/or repair instructions to repair the fault to the diagnostic tool 100.

3. Conclusion

The embodiments described in the present application may be used in and applied to a number of situations involving the diagnosis and repair of fault conditions in automotive vehicles. The use or application of the embodiments described herein also provide several advantages over the prior art. For instance, by leveraging remote processing power and storage capacity (collectively referred to herein as “computing power”), the system and method of the present application allow handheld devices with slower processing power and smaller storage capacity than personal computers (PC) or workstations to be used as diagnostic tools. Moreover, using the processing power and storage of the remote host may provide battery power conservation for the diagnostic tool (e.g., handheld device). In addition, the system and method of the present application allow diagnostic data to be conveniently updated at a central location (i.e., the remote host), as opposed to individually at each diagnostic tool. As a result, diagnostic information may be quickly and efficiently updated, with the diagnostic tools of the present application having access to the latest and most up-to-date diagnostic information available via their connection with the remote host.

An embodiment of the present application has been described above. Those skilled in the art will understand, however, that changes and modifications may be made to this embodiment without departing from the true scope and spirit of the present application, which is defined by the claims.

We claim:

1. A diagnostic tool comprising:
a processing unit;
a vehicle communication interface;
a network communication interface;
an output device for communicating with a user;
a data storage; and
a diagnostic routine executable by the processing unit to (i) download data from the on-board computer of a vehicle, (ii) communicate with a remote host, and (iii) provide diagnosis information to the user;
wherein the diagnostic tool receives data from the on-board computer of the vehicle via the vehicle communication interface, and communicates with the remote host via the network communication interface.

2. The diagnostic tool of claim 1 wherein the vehicle communication interface comprises a scanner.

3. The diagnostic tool of claim 1 wherein the network communication interface comprises one of a wireless network device or a wired network device.

4. The diagnostic tool of claim 3, wherein the wireless network device comprises a wireless communication interface arranged to communicate over an air interface with a network.

5. The diagnostic tool of claim 1 wherein the network communication interface communicates with the remote host via at least one network.

6. The diagnostic tool of claim 1 wherein the diagnostic tool is a handheld device.

7. The diagnostic tool of claim 1 wherein the diagnosis information comprises at least one of a fault description or repair instructions.

8. A diagnostic system comprising:
a remote host accessible via a network; and
a diagnostic tool comprising:
a processing unit;
a vehicle communication interface;
a network communication interface;
an output device for communicating with a user;
a data storage; and
a diagnostic routine executable by the processing unit to (i) download data from the on-board computer of a vehicle, (ii) communicate with the remote host, and (iii) provide diagnosis information to the user;
wherein the diagnostic tool receives data from the on-board computer of the vehicle via the vehicle communication interface, and communicates with the remote host via the network communication interface; and
wherein the remote host responds to the communication from the diagnostic tool by (i) diagnosing a vehicle fault and (ii) communicating information regarding the vehicle fault to the diagnostic tool.

9. The diagnostic system of claim 8 wherein the vehicle communication interface comprises a scanner.

10. The diagnostic system of claim 8 wherein the network communication interface comprises one of a wireless network device or a wired network device.

11. The diagnostic system of claim 10, wherein the wireless network device comprises a wireless communication interface arranged to communicate over an air interface with the network.

12. The diagnostic system of claim 8 wherein the network communication interface communicates with the remote host via the network.

13. The diagnostic system of claim 8 wherein the diagnostic tool is a handheld device.

14. The diagnostic system of claim 8 wherein the information regarding the vehicle fault comprises at least one of a fault description or repair instructions.

15. The diagnostic system of claim 8 wherein the diagnosis information comprises at least one of a fault description or repair instructions.

16. A method of diagnosing a vehicle fault using a diagnostic tool, the method comprising:
downloading vehicle information from the vehicle's on-board computer;
determining whether additional computing power is required to diagnose the vehicle fault;
in response to the determination, establishing a connection with a remote host;
sending at least a portion of the vehicle information to the remote host;
receiving diagnosis information from the remote host; and
outputting the diagnosis information to a user.

17. The method of claim 16 wherein determining whether additional computing power is required includes initiating a vehicle fault diagnosis process on the diagnostic tool.

18. The method of claim 16 wherein additional computing power comprises at least one of additional processing power or access to a database external to the diagnostic tool.

19. The method of claim 16 wherein the diagnostic tool outputs the diagnosis information to the user via at least one of a display and a speaker.

20. The method of claim 16 wherein the diagnosis information comprises at least one of a vehicle fault description and repair instructions.
